(19) United States
(12) Patent Application Publication
(10) Pub. No.: US 2024/0181487 A1
(43) Pub. Date: Jun. 6, 2024

(54) COATING DIE HEAD

(71) Applicant: INDUSTRIAL TECHNOLOGY RESEARCH INSTITUTE, Hsinchu (TW)

(72) Inventors: Ping-Yao WU, Taipei City (TW); Wen-Bing CHU, Hsinchu City (TW)

(73) Assignee: INDUSTRIAL TECHNOLOGY RESEARCH INSTITUTE, Hsinchu (TW)

(21) Appl. No.: 18/107,705

(22) Filed: Feb. 9, 2023

(30) Foreign Application Priority Data
Dec. 5, 2022 (TW) 111146553

(51) Int. Cl. B05C 5/02; B05C 9/06

(52) U.S. Cl. CPC B05C 5/027; B05C 5/0254; B05C 9/06

(57) ABSTRACT

A coating die head includes a first die block, a second die block, a third die block, and a fourth die block that are sequentially arranged at intervals. The first die block and the second die block form a first slot therebetween, the second die block and the third die block form a second slot therebetween, and the third die block and the fourth die block form a third slot therebetween. Each of the first die block, the second die block, the third die block, and the fourth die block has a die lip at a surface thereof. A length of the die lip of the second die block ranges from 100 micrometers to 200 micrometers. A ratio of a length of the die lip of the third die block to the length of the die lip of the second die block ranges from 1.5 to 7.

### CROSS-REFERENCE TO RELATED APPLICATIONS

This non-provisional application claims priority under 35 U.S.C. § 119(a) on Patent Application No(s). 111146553 filed in Taiwan, R.O.C. on Dec. 5, 2022, the entire contents of which are hereby incorporated by reference.

### TECHNICAL FIELD

The present disclosure relates to a coating die head, more particularly to a multi-layer slot coating die head.

### BACKGROUND

As the expansion of the material application field, more products are applied with coated films than ever. The coated film may be a single layer or a stack of multi-layers. The multi-layers can be coated at the same time or by forming the layers one by one. For the enhancement of efficiency, some manufactures tend to form the multi-layer film at the same time.

In order to coat multi-layers at the same time, a plurality of materials are extruded from the die head to be coated on the substrate at the same time. However, in the coating process, the configuration at the side of the die head close to the substrate during coating (referred as the die lip in the present disclosure) will affect the stability of the flow field formed by the materials when being extruded. If the flow field is unstable, the material of one layer may penetrate into the material of the adjacent layer, or air may flow into the extruded materials, leading the coated film cannot be uniform in each layer.

### SUMMARY

The present disclosure provides a coating die head capable of forming a multi-layer film.

According to one embodiment of the present disclosure, a coating die head configured to coat a multi-layer film on a substrate simultaneously includes a first die block, a second die block, a third die block, and a fourth die block that are sequentially arranged at intervals. The first die block and the second die block form a first slot therebetween, the second die block and the third die block form a second slot therebetween, and the third die block and the fourth die block form a third slot therebetween. Each of the first die block, the second die block, the third die block, and the fourth die block has a die lip at a surface thereof configured to be located close to the substrate. A length of the die lip of the second die block ranges from 100 micrometers to 200 micrometers, and a ratio of a length of the die lip of the third die block to the length of the die lip of the second die block ranges from 1.5 to 7.

According to the coating die head discussed above, by designing the lengths of the die lips, materials can immediately flow together to form a stable flow as soon as the materials leave the coating die head. As such, a uniform multi-layer film can be provided.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a cross-sectional view of a coating die head according to an embodiment of the present disclosure;

FIG. 2 is a schematic view showing that the coating die head in FIG. 1 simultaneously coats a three-layer film on a substrate;

FIG. 3a to FIG. 3c are schematic view showing coating bead simulation results of a coating die head according to an embodiment of the present disclosure;

FIG. 4a to FIG. 4c are schematic view showing coating bead simulation results of a coating die head according to another embodiment of the present disclosure;

FIG. 5a to FIG. 5b are schematic view showing coating bead simulation results of a coating die head according to a comparison example;

FIG. 6a to FIG. 6b are schematic view showing coating bead simulation results of a coating die head according to another comparison example; and

FIG. 7 is a cross-sectional view of a dry film coated from an embodiment of the present disclosure and imaged by an electron microscope.

### DETAILED DESCRIPTION

Embodiments and advantages of the disclosure will become apparent from the following detailed descriptions with the accompanying drawings. For purposes of explanation, one or more specific embodiments are given to provide a thorough understanding of the disclosure, and which are described in sufficient detail to enable one skilled in the art to practice the described embodiments. It should be understood that the following descriptions are not intended to limit the embodiments to one specific embodiment. On the contrary, it is intended to cover alternatives, modifications, and equivalents as can be included within the spirit and scope of the described embodiments as defined by the appended claims.

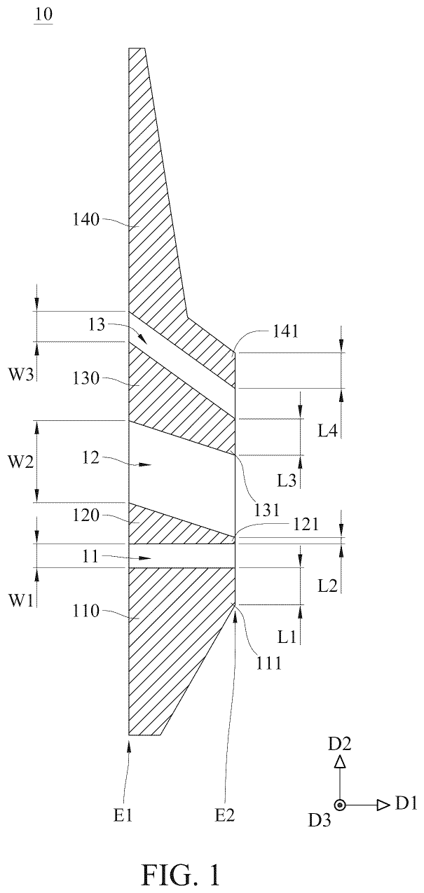

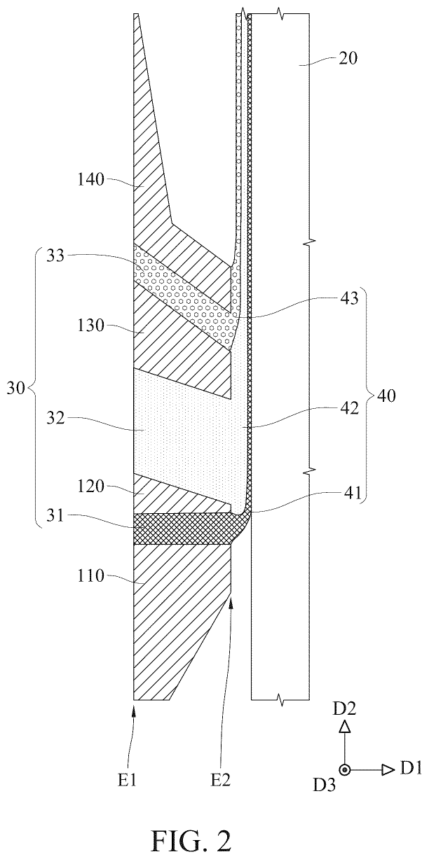

Please refer to FIG. 1 and FIG. 2, where FIG. 1 is a cross-sectional view of a coating die head according to an embodiment of the present disclosure, and FIG. 2 is a schematic view showing that the coating die head in FIG. 1 simultaneously coats a three-layer film on a substrate.

A coating die head 10 according to an embodiment of the present disclosure may be a die head applicable to the slot-die coating technique. Specifically, the coating die head 10 is configured to simultaneously coat a plurality of materials 30 on a substrate 20 (e.g., copper foil or polyethylene terephthalate (PET)) so as to form a multi-layer film 40.

The coating die head 10 has an inlet side E1 and an outlet side E2. The coating die head 10 includes a first die block 110, a second die block 120, a third die block 130, and a fourth die block 140 that are sequentially arranged at intervals. Each of the first die block 110, the second die block 120, the third die block 130, and the fourth die block 140 has a die lip (111, 121, 131 and 141) at a surface thereof configured to be located close to the substrate 20. Herein, in FIG. 1 and FIG. 2, a direction from the inlet side E1 to the outlet side E2 is defined as a first direction D1, a direction from the first die block 110 to the fourth die block 140 is defined as a second direction D2, and a direction perpendicular to the first direction D1 and the second direction D2 is defined as a third direction D3.

The first die block 110 and the second die block 120 jointly form a first slot 11 therebetween, the second die block 120 and the third die block 130 jointly form a second slot 12 therebetween, and the third die block 130 and the fourth die block 140 jointly form a third slot 13 therebetween. The first slot 11, the second slot 12, and the third slot 13 each have an inlet located at the inlet side E1 and an outlet located at the outlet side E2.

A distance between the first die block 110 and the second die block 120 can be considered as a gap W1 of the first slot 11. A distance between the second die block 120 and the third die block 130 can be considered as a gap W2 of the second slot 12. A distance between the third die block 130 and the fourth die block 140 can be considered as a gap W3 of the third slot 13. According to an embodiment of the present disclosure, the gap W1 of the first slot 11 may range from 50 micrometers (m) to 500 μm; the gap W2 of the second slot 12 may range from 100 μm to 1200 μm; the gap W3 of the third slot 13 may range from 50 μm to 500 μm. Note that each gap W1 to W3 of the slots 11 to 13 is adjustable according to product requirements, operation conditions or coating properties, and the present disclosure is not limited thereto.

A length of the die lip 111 of the first die block 110 is L1, a length of the die lip 121 of the second die block 120 is L2, a length of the die lip 131 of the third die block 130 is L3, and a length of the die lip 141 of the fourth die block 140 is L4. According to an embodiment of the present disclosure, the length L2 of the die lip 121 of the second die block 120 ranges from 100 μm to 200 μm. A ratio of the length L3 of the die lip 131 of the third die block 130 to the length L2 of the die lip 121 of the second die block 120 (L3/L2) ranges from 1.5 to 7. The sum of the length L2 of the die lip 121 of the second die block 120, the length L3 of the die lip 131 of the third die block 130, and the length L4 of the die lip 141 of the fourth die block 140 may range from 0.7 millimeters (mm) to 3 mm. According to an embodiment of the present disclosure, the length L1 of the die lip 111 of the first die block 110 may range from 200 μm to 1000 μm; the length L3 of the die lip 131 of the third die block 130 may range from 150 μm to 1400 μm; and the length L4 of the die lip 141 of the fourth die block 140 may range from 200 μm to 1000 μm.

The materials 30 for die coating includes a first material 31, a second material 32 and a third material 33. Each of the first material 31, the second material 32, and the third material 33 may be made of thermoplastic polyimide (TPI), polyimide (PI), modified polyimide (MPI) or optical clear adhesive (OCA). For example, the combination of the first material 31, the second material 32, and the third material 33 may be TPI/PI/TPI or OCA1/OCA2/OCA1, wherein OCA1 and OCA2 represent two different optical clear adhesives. The first material 31, the second material 32, and the third material 33 respectively fed by the first slot 11, the second slot 12, and the third slot 13 are extruded from the coating die head 10 at the outlet side E2 along the first direction D1 to respectively form a lower layer 41, a middle layer 42, and an upper layer 43 on the substrate 20.

By designing the lengths of the die lips within a proper range, the first material 31 can immediately flow together with the second material 32 to form a stable flow as soon as the first material 31 leaves the coating die head 10. As such, the lower layer 41, the middle layer 42, and the upper layer 43 can form a uniform multi-layer film 40. Moreover, the abovementioned proper lengths of the die lips can be collaborated with a proper configuration of the gaps of the slots, so that the film 40 with a relatively thin lower layer 41 can be formed.

The coating die head 10 may further includes a fastener (not shown). The fastener may be a screw and can fix the first die block 110, the second die block 120, the third die block 130, and the fourth die block 140 together. With the existence of the fastener, the distances between the die blocks can be fixed. Moreover, the fixed distances can be collaborated with the abovementioned proper lengths of the die lips, so that the thickness of each layer of the film 40 can accurately fall within a desired range. Further, each die block is an integrated structure, and the width of each die block along the third direction D3 can be easily changed by replacing each die block, so that the width of the film 40 can meet the product requirements.

Moreover, at the outlet side E2, the die lip 111 of the first die block 110, the die lip 121 of the second die block 120, the die lip 131 of the third die block 130, and the die lip 141 of the fourth die block 140 are substantially flush with one another. As such, it is helpful to improve the assembly of the coating die head 10 and facilitate the alignment of the die blocks.

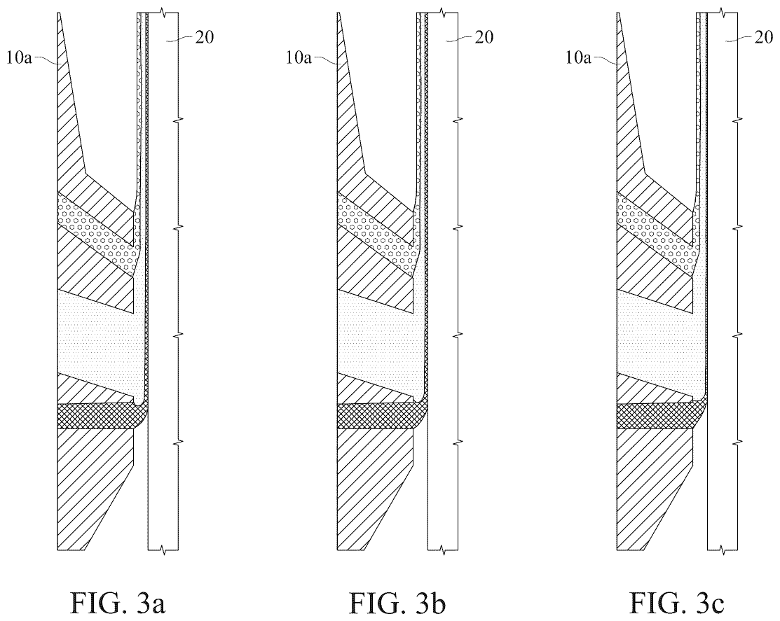

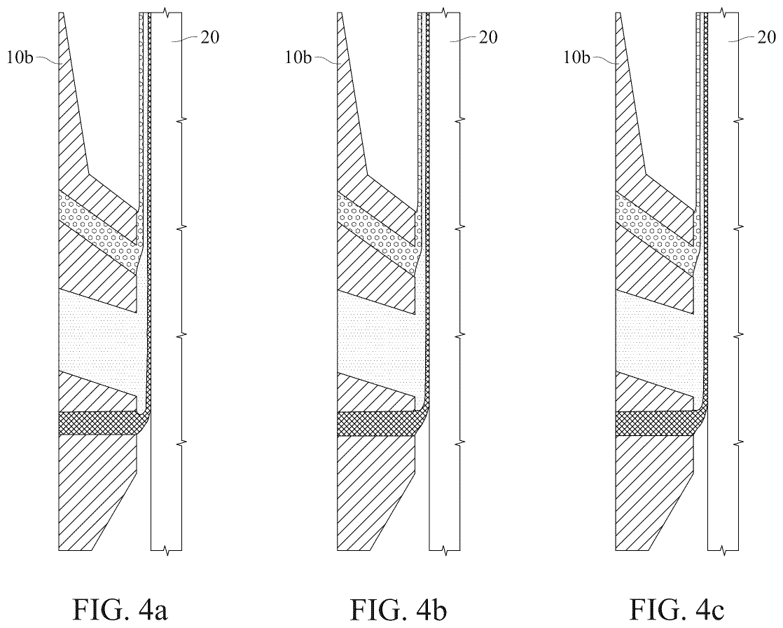

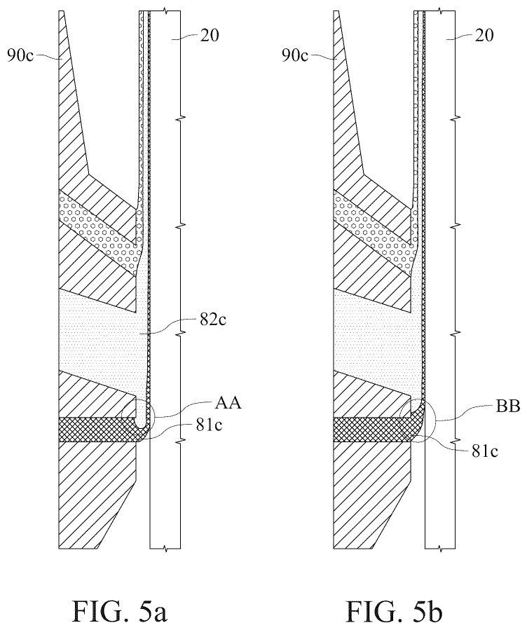

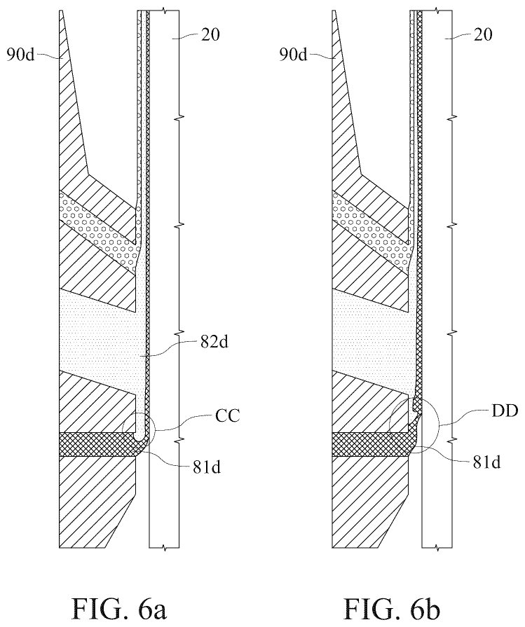

Please further refer to FIG. 3a to FIG. 6b, where FIG. 3a to FIG. 3c are schematic view showing coating bead simulation results of a coating die head according to an embodiment of the present disclosure, FIG. 4a to FIG. 4c are schematic view showing coating bead simulation results of a coating die head according to another embodiment of the present disclosure, FIG. 5a to FIG. 5b are schematic view showing coating bead simulation results of a coating die head according to a comparison example, and FIG. 6a to FIG. 6b are schematic view showing coating bead simulation results of a coating die head according to another comparison example.

In the embodiments referring to FIG. 3a to FIG. 4c and the comparison examples referring to FIG. 5a to FIG. 6b, coating die heads 10a, 10b, 90c, and 90d with different lengths of die lips are used to perform coating processes on the substrate 20.

In the embodiment referring to FIG. 3a to FIG. 3c, the length of the die lip of the first die block was L1, the length of the die lip of the second die block was L2, the length of the die lip of the third die block was L3, the length of the die lip of the fourth die block was L4, and their dimensions were as follows: L1=500 μm; L2=100 μm; L3=500 μm; L4=500 μm; L3/L2=5; and L2+L3+L4=1.1 mm. As shown in FIG. 3a to FIG. 3c, each layer of coated film was uniform and can meet the requirements of film formation.

In the embodiment referring to FIG. 4a to FIG. 4c, the length of the die lip of the first die block was L1, the length of the die lip of the second die block was L2, the length of the die lip of the third die block was L3, the length of the die lip of the fourth die block was L4, and their dimensions were as follows: L1=500 μm; L2=200 μm; L3=500 μm; L4=500 μm; L3/L2=2.5; and L2+L3+L4=1.2 mm. As shown in FIG. 4a to FIG. 4c, each layer of coated film was uniform and can meet the requirements of film formation.

In the comparison example referring to FIG. 5a to FIG. 5b, the length of the die lip of the first die block was L1, the length of the die lip of the second die block was L2, the length of the die lip of the third die block was L3, the length of the die lip of the fourth die block was L4, and their dimensions were as follows: L1=500 μm; L2=300 μm (larger than 200 μm, the upper limited value of the present disclosure); L3=500 μm; L4=500 μm; L3/L2=1.67; and L2+L3+L4=1.3 mm.

As shown in FIG. 5a to FIG. 5b, the middle layer 82c in the AA region of FIG. 5a penetrates into the lower film 81c, and there was some air flowing into the lower film 81c in the BB region of FIG. 5b. Therefore, the two simulation results shown in FIG. 5a and FIG. 5b were determined as unable to form a uniform multi-layer film.

In the comparison example referring to FIG. 6a to FIG. 6b, the length of the die lip of the first die block was L1, the length of the die lip of the second die block was L2, the length of the die lip of the third die block was L3, the length of the die lip of the fourth die block was L4, and their dimensions were as follows: L1=500 μm; L2=500 μm (larger than 200 μm, the upper limited value of the present disclosure); L3=500 μm; L4=500 μm; L3/L2=1; and L2+L3+L4=1.5 mm.

As shown in FIG. 6a to FIG. 6b, the middle layer 82d in the CC region of FIG. 6a penetrates into the lower film 81d, and there was some air flowing into the lower film 81d in the DD region of FIG. 6b. Therefore, the two simulation results shown in FIG. 6a and FIG. 6b were determined as unable to form a uniform multi-layer film.

Besides the above embodiments and comparison examples, additional simulations for coating die heads with different sizes were performed. The sizes of the coating die heads and the simulation results for determining whether to form a uniform multi-layer film (success in film formation/failure at film formation) were listed in Table 1, wherein the length of the die lip of the first die block was L1, the length of the die lip of the second die block was L2, the length of the die lip of the third die block was L3, the length of the die lip of the fourth die block was L4.

TABLE 1

| | L1 | L2 | L3 | L4 | Film |
|---|---|---|---|---|---|
| | (μm) | (μm) | (μm) | (μm) | Formation |
| Simulation embodiment 1 | 300 | 100 | 300 | 300 | Success |
| Simulation comparison | 300 | 100 | 710 | 2190 | Failure |
| example 1 | | | | | |
| Simulation comparison | 300 | 100 | 140 | 2760 | Failure |
| example 2 | | | | | |
| Simulation comparison | 300 | 200 | 280 | 2520 | Failure |
| example 3 | | | | | |
| Simulation embodiment 2 | 300 | 200 | 300 | 300 | Success |
| Simulation embodiment 3 | 300 | 200 | 300 | 2500 | Success |
| Simulation embodiment 4 | 300 | 200 | 1300 | 1500 | Success |
| Simulation embodiment 5 | 300 | 200 | 1400 | 1400 | Success |
| Simulation comparison | 300 | 200 | 1450 | 1350 | Failure |
| example 4 | | | | | |
| Simulation comparison | 300 | 300 | 300 | 300 | Failure |
| example 5 | | | | | |
| Simulation embodiment 6 | 500 | 100 | 500 | 500 | Success |
| Simulation embodiment 7 | 500 | 200 | 500 | 500 | Success |
| Simulation comparison | 500 | 300 | 500 | 500 | Failure |
| example 6 | | | | | |
| Simulation comparison | 500 | 500 | 500 | 500 | Failure |
| example 7 | | | | | |
| Simulation embodiment 8 | 700 | 100 | 700 | 700 | Success |
| Simulation embodiment 9 | 700 | 200 | 700 | 700 | Success |
| Simulation comparison | 700 | 300 | 700 | 700 | Failure |
| example 8 | | | | | |

According to Table 1, a die head with the following conditions can coat a uniform multi-layer film: the length of the die lip of the second die block (L2) ranges from 100 μm to 200 μm, a ratio of the length of the die lip of the third die block to the length of the die lip of the second die block (L3/L2) ranges from 1.5 to 7, and the sum of the length of the die lip of the second die block, the length of the die lip of the third die block and the length of the die lip of the fourth die block (L2+L3+L4) can range from 0.7 mm to 3 mm.

In order to make the abovementioned and other purposes, features, and advantages of the present disclosure more obvious and easy to be understand, several embodiments below are described in detail with the accompanying drawings:

### First Embodiment

The length of the die lip 111 of the first die block 110 was L1, the length of the die lip 121 of the second die block 120 was L2, the length of the die lip 131 of the third die block 130 was L3, the length of the die lip 141 of the fourth die block 140 was L4, and their dimensions were as follows: L1=500 μm; L2=150 μm; L3=500 μm; L4=500 μm; L3/L2=3.33; and L2+L3+L4=1.15 mm. The gap of the first slot 11 was 300 μm, the gap of the second slot 12 was 1000 μm, and the gap of the third slot 13 is 300 μm. The combination of the first material 31, the second material 32, and the third material 33 was TPI/PI/TPI, whose viscosities were respectively 9346 cps, 15280 cps, and 3008 cps, and 1 cps=1 mPa·s. The coating width of the coating die head 10 is 535 mm. The coating die head 10 applied the materials 30 on the substrate 20 made of copper foil along a direction opposite to the second direction D2 at a coating speed of 2 meter per minute with respect to the substrate 20. The formed multi-layer film had a good appearance and meets the product requirements after being dried.

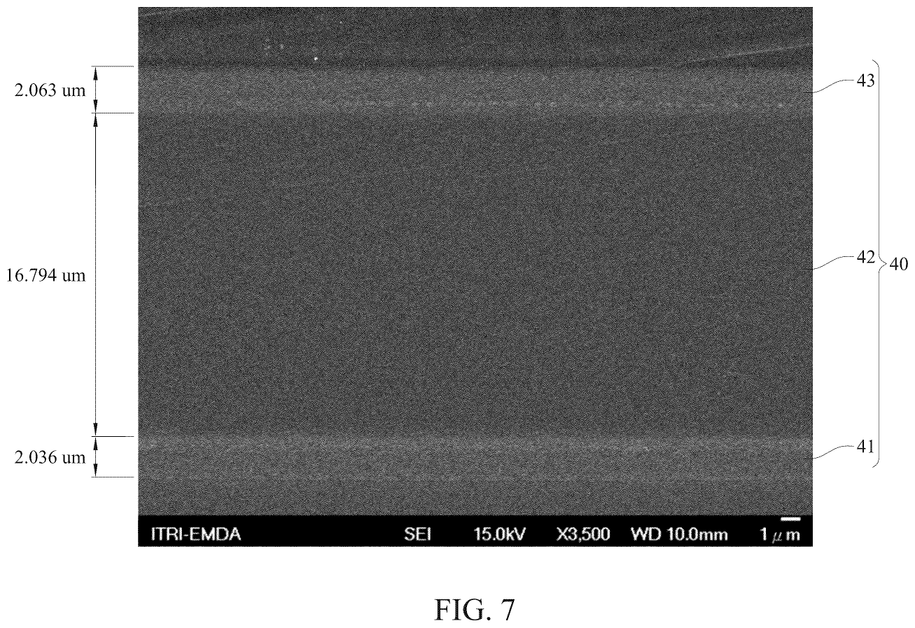

The film 40 initially formed on the substrate 20 was called “a wet film”. When the film 40 was completely dried by a drying process, the dried film 40 at this stage was called “a dry film”. The dried film 40 (dry film) can be cut for observing its cross section, and the cross-sectional view thereof imaged by a scanning electron microscope (SEM) was shown in FIG. 7. As shown, the thicknesses of the lower layer 41, the middle layer 42, and the upper layer 43 of the dry film were respectively 2.036 μm, 16.794 μm, and 2.063 μm. The thicknesses of the lower layer 41, the middle layer 42, and the upper layer 43 of the wet film initially formed on the substrate 20 can be calculated according to the thicknesses of the dry film, which were respectively 32.48 μm, 232.53 μm, and 32.07 μm. Therefore, the thickness ratio of the lower layer 41, the middle layer 42, and the upper layer 43 of the wet film was 1:7.16:0.99, wherein the ratio of the thickness of the middle layer 42 to the thickness of the lower layer 41 was up to 7 times or more, and each of the thicknesses of the lower layer 41 and the upper layer 43 was much smaller than that of the middle layer.

### Second Embodiment

The die lips of the coating die head 10 in this embodiment and the die lips of the coating die head 10 in the first embodiment were the same in size, whereas the coating width of the coating die head 10 in this embodiment was 300 mm. In this embodiment, the combination of the first material 31, the second material 32, and the third material 33 was OCA1/OCA2/OCA1, whose viscosities were respectively 1950 cps, 4400 cps, and 1950 cps. The coating die head 10 applied the materials 30 on the substrate 20 made of PET along a direction opposite to the second direction D2 at a coating speed of 0.5 meter per minute with respect to the substrate 20. The formed multi-layer film had a good appearance and meets the product requirements after being dried.

When the film 40 was dried, the target thicknesses of the lower layer 41, the middle layer 42, and the upper layer 43 of the dry film (dried film 40) were respectively 5 μm, 240 μm, and 5 μm. The thicknesses of the lower layer 41, the middle layer 42, and the upper layer 43 of the wet film initially formed on the substrate 20 can be calculated according to the thicknesses of the dry film, which were respectively 12.6 μm, 516.1 μm, and 12.6 μm. Therefore, the thickness ratio of the lower layer 41, the middle layer 42, and the upper layer 43 of the wet film was 1:40.98:1, wherein the ratio of the thickness of the middle layer 42 to the thickness of the lower layer 41 was up to 40 times or more, and each of the thicknesses of the lower layer 41 and the upper layer 43 was much smaller than that of the middle layer.

### Third Embodiment

The die lips of the coating die head 10 in this embodiment and the die lips of the coating die head 10 in the first embodiment are the same in size, whereas the coating width of the coating die head 10 in this embodiment was 300 mm. In this embodiment, the combination of the first material 31, the second material 32, and the third material 33 was OCA1/OCA2/OCA1, whose viscosities are respectively 1950 cps, 4400 cps, and 1950 cps. The coating die head 10 applied the materials 30 on the substrate 20 made of PET along a direction opposite to the second direction D2 at a coating speed of 0.5 meter per minute with respect to the substrate 20. The formed multi-layer film had a good appearance and meets the product requirements after being dried.

When the film 40 was dried, the target thicknesses of the lower layer 41, the middle layer 42, and the upper layer 43 of the dry film (dried film 40) are respectively 5 μm, 90 μm, and 5 μm. The thicknesses of the lower layer 41, the middle layer 42, and the upper layer 43 of the wet film initially formed on the substrate 20 can be calculated according to the thicknesses of the dry film, which were respectively 12.6 μm, 193.5 μm, and 12.6 μm. Therefore, the thickness ratio of the lower layer 41, the middle layer 42, and the upper layer 43 of the wet film was 1:15.37:1, wherein the ratio of the thickness of the middle layer 42 to the thickness of the lower layer 41 was up to 15 times or more, and each of the thicknesses of the lower layer 41 and the upper layer 43 was much smaller than that of the middle layer.

According to the coating die head discussed above, by designing the lengths of the die lips within a proper range, the first material can immediately flow together with the second material to form a stable flow as soon as the first material leaves the coating die head. As such, the lower layer, the middle layer, and the upper layer can form a uniform multi-layer film. Moreover, the abovementioned proper lengths of the die lips can be collaborated with a proper configuration of the gaps of the slots, so that the film with a relatively thin lower layer can be formed.

The embodiments are chosen and described in order to best explain the principles of the present disclosure and its practical applications, to thereby enable others skilled in the art best utilize the present disclosure and various embodiments with various modifications as are suited to the particular use being contemplated. It is intended that the scope of the present disclosure is defined by the following claims and their equivalents.

What is claimed is:

1. A coating die head, configured to coat a multi-layer film on a substrate simultaneously, the coating die head comprising a first die block, a second die block, a third die block, and a fourth die block that are sequentially arranged at intervals, wherein the first die block and the second die block form a first slot therebetween, the second die block and the third die block form a second slot therebetween, the third die block and the fourth die block form a third slot therebetween, each of the first die block, the second die block, the third die block, and the fourth die block has a die lip at a surface thereof configured to be located close to the substrate, a length of the die lip of the second die block ranges from 100 micrometers to 200 micrometers, and a ratio of a length of the die lip of the third die block to the length of the die lip of the second die block ranges from 1.5 to 7.

2. The coating die head according to claim 1, wherein a sum of the length of the die lip of the second die block, the length of the die lip of the third die block, and a length of the die lip of the fourth die block ranges from 0.7 millimeters to 3 millimeters.

3. The coating die head according to claim 1, wherein the die lip of the die block, the die lip of the second die block, the die lip of the third die block, and the die lip of the fourth die block are substantially flush with one another.

4. The coating die head according to claim 1, wherein a gap of the first slot ranges from 50 micrometers to 500 micrometers, a gap of the second slot ranges from 100 micrometers to 1200 micrometers, and a gap of the third slot ranges from 50 micrometers to 500 micrometers.

5. The coating die head according to claim 1, wherein a length of the die lip of the first die block ranges from 200 micrometers to 1000 micrometers.

6. The coating die head according to claim 1, wherein the length of the die lip of the third die block ranges from 150 micrometers to 1400 micrometers.

7. The coating die head according to claim 1, wherein a length of the die lip of the fourth die block ranges from 200 micrometers to 1000 micrometers.
